(19) United States
(12) Patent Application Publication
(10) Pub. No.: US 2005/0084022 A1
(43) Pub. Date: Apr. 21, 2005

(54) Receiving apparatus, transmission system, and transmission method

(76) Inventor: Takehiko Okuyama, Yokohama-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/935,122

(22) Filed: Sep. 8, 2004

(30) Foreign Application Priority Data
Sep. 12, 2003 (JP) 2003-320941

(51) Int. Cl. H04L 1/00

(52) U.S. Cl. 375/259

(57) ABSTRACT

A receiving apparatus includes an input unit which obtains identification information from a transmitting apparatus through a conductor and a receiving unit which receives and decodes information wirelessly transmitted from the transmitting apparatus when the identification information permits decoding.

### CROSS-REFERENCE TO RELATED APPLICATIONS

This application is based upon and claims the benefit of priority from prior Japanese Patent Application No. 2003-320941, filed Sep. 12, 2003, the entire contents of which are incorporated herein by reference.

### BACKGROUND OF THE INVENTION

1. Field of the Invention

The present invention relates to a transmission system including a receiving apparatus and a transmitting apparatus, particularly to the receiving apparatus, the transmitting apparatus, the transmission system, and a transmission method for easily setting an ID between the receiving apparatus and the transmitting apparatus.

2. Description of the Related Art

Recently, various kinds of digital devices have been developed, manufactured, and come into widespread use, and communication of digital is easily performed between these digital devices. However, because digital information is easily handed, it has been difficult to protect a copyright of the content. Therefore, in order to protect the content, communication is performed after identification processing of the digital device is performed.

A wireless communication system between a server apparatus and a client apparatus, in which digital information is transmitted and received, is shown in Patent Reference 1. In this case, the content in which a broadcasting signal is received and decoded is supplied from the server apparatus to the client apparatus. Unique apparatus identification information (apparatus ID) is previously given to the client apparatus so that the content is not easily copied by another apparatus and can be received only by the dedicated client apparatus. Therefore, even if a third party maliciously tries to obtain the content from the server apparatus by using another digital device, the content can not be obtained because the apparatus ID is not given to the digital device of the third party.

As in the case of Jpn. Pat. Appln. KOKAI Publication No. 2002-198957 which is prior art, when the apparatus ID is given to the client apparatus, for example during shipment from a factory, there is no problem in the case where initially a set of the server apparatus and the client apparatus is manufactured and purchased. However, when a user wants to purchase on additional client apparatus after that, since it is necessary to prepare the client apparatus having the apparatus ID corresponding to the server apparatus which has been initially purchased, there is a problem that the addition of the client apparatus becomes very difficult.

### BRIEF SUMMARY OF THE INVENTION

An embodiment of the invention is a receiving apparatus having an input unit which obtains identification information from an external transmitting apparatus through a conductor and a receiving unit which receives and decodes the information wirelessly transmitted from the transmitting apparatus when the identification information given from the input unit permits decoding.

### BRIEF DESCRIPTION OF THE SEVERAL VIEWS OF THE DRAWING

FIG. 1 shows an example of connection and communication between a transmitting apparatus and a receiving apparatus according to the invention;

FIG. 2 shows an example of the connection and the communication between the transmitting apparatus and the receiving apparatus which are of cradles according to the invention;

FIG. 3 shows another example of the connection and the communication between the transmitting apparatus and the receiving apparatus according to the invention;

FIG. 4 is a block diagram showing an example of a configuration of the transmitting apparatus according to the invention;

FIG. 5 is a block diagram showing an example of the configuration of the receiving apparatus according to the invention;

FIG. 6 is a block diagram showing another example of the configuration of the transmitting apparatus according to the invention;

FIG. 7 is a block diagram showing another example of the configuration of the receiving apparatus according to the invention;

FIG. 8 is a flowchart showing an example of ID setting and communication processing between the transmitting apparatus and the receiving apparatus according to a first embodiment of the invention;

FIG. 9 is a flowchart showing another example of the ID setting and the communication processing between the transmitting apparatus and the receiving apparatus according to a second embodiment of the invention;

FIG. 10 is a flowchart showing another example of the ID setting and the communication processing between the transmitting apparatus and the receiving apparatus according to a third embodiment of the invention;

FIG. 11 shows an example of an operation screen for prompting a user to perform the ID setting of the transmitting apparatus according to the invention; and

FIG. 12 shows an example of the operation screen showing completion of the ID setting of the transmitting apparatus according to the invention.

### DETAILED DESCRIPTION OF THE INVENTION

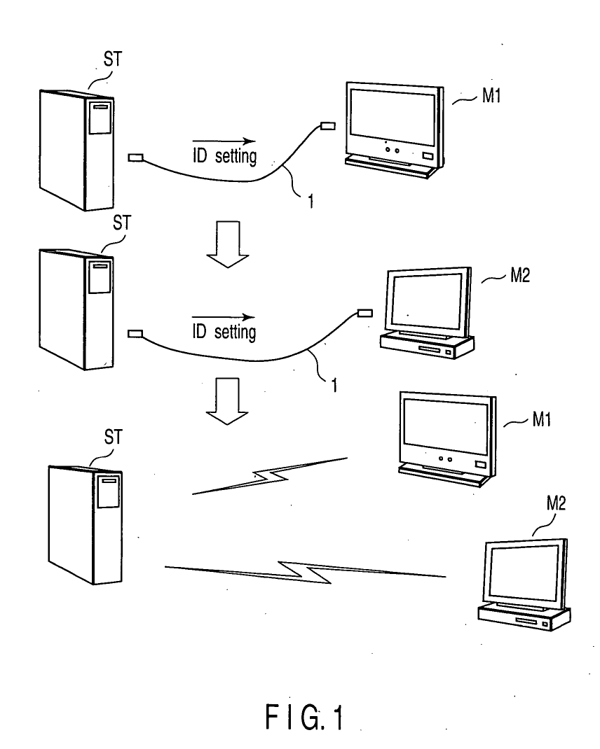

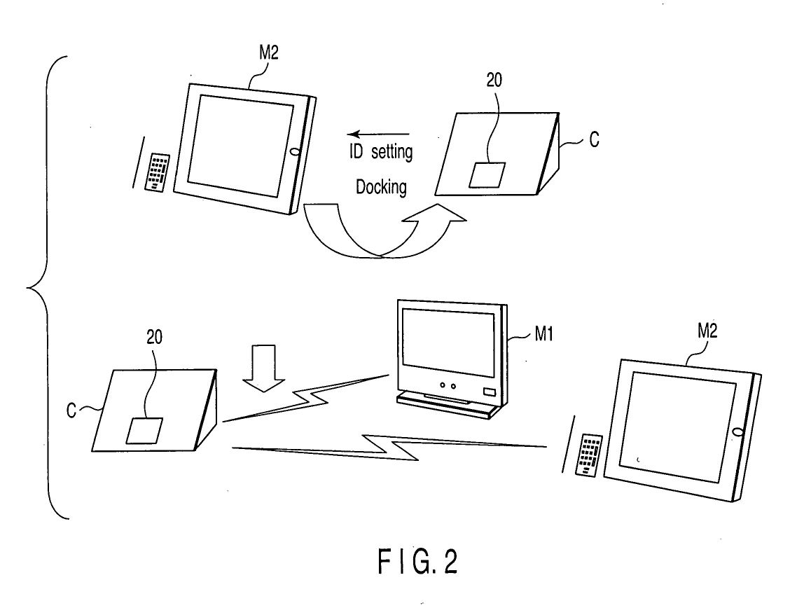

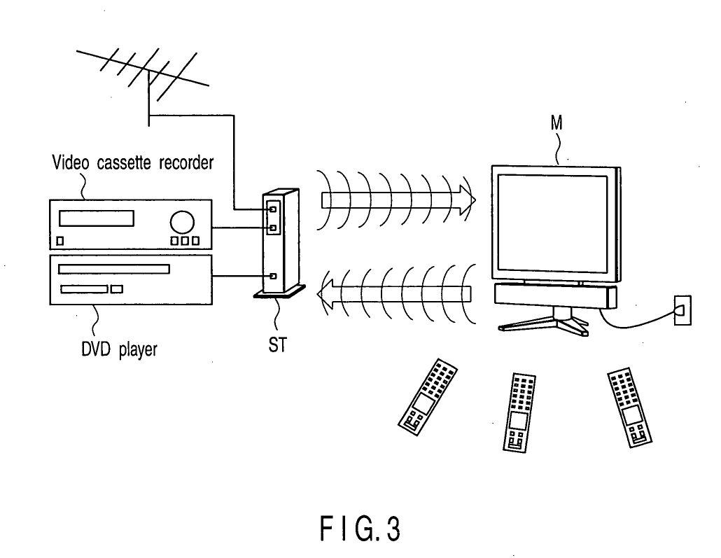

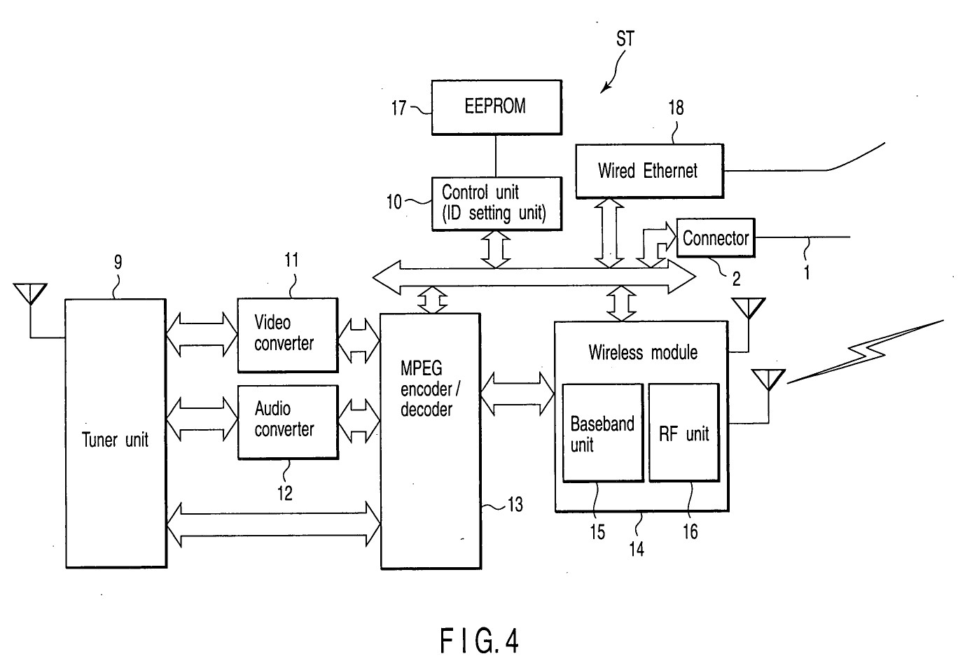

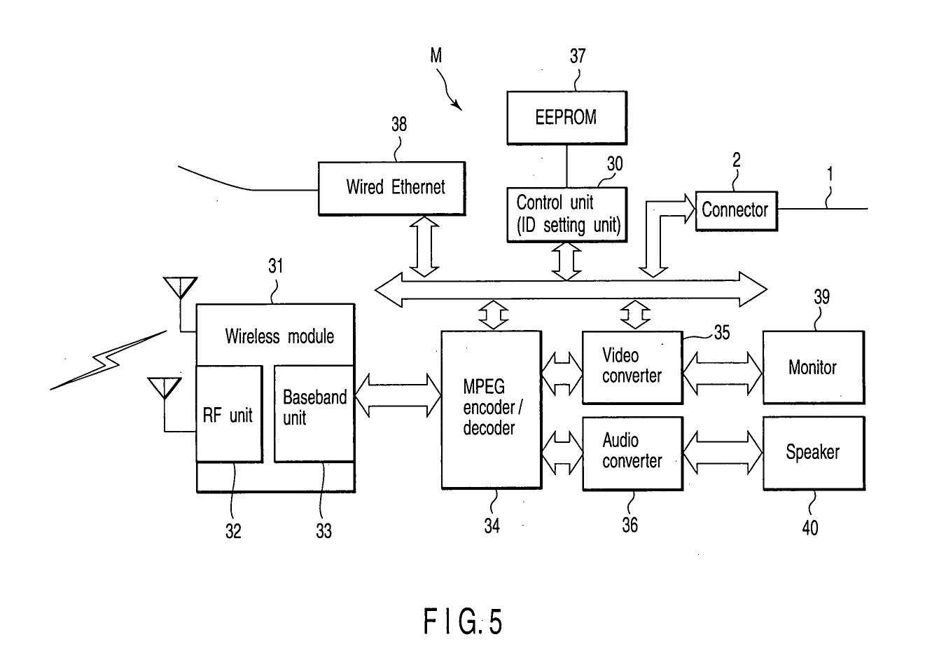

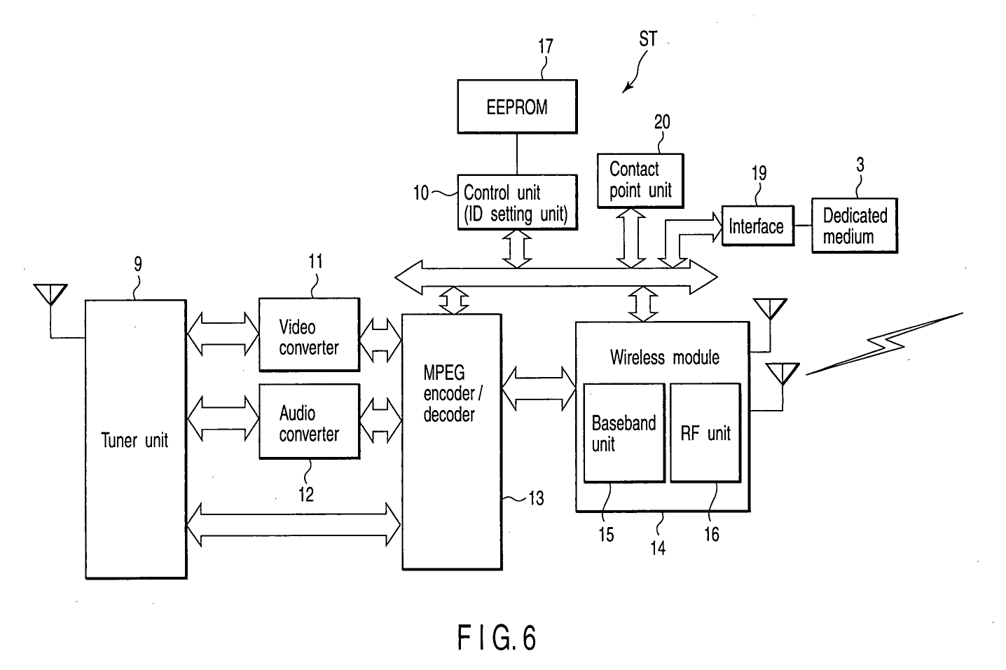

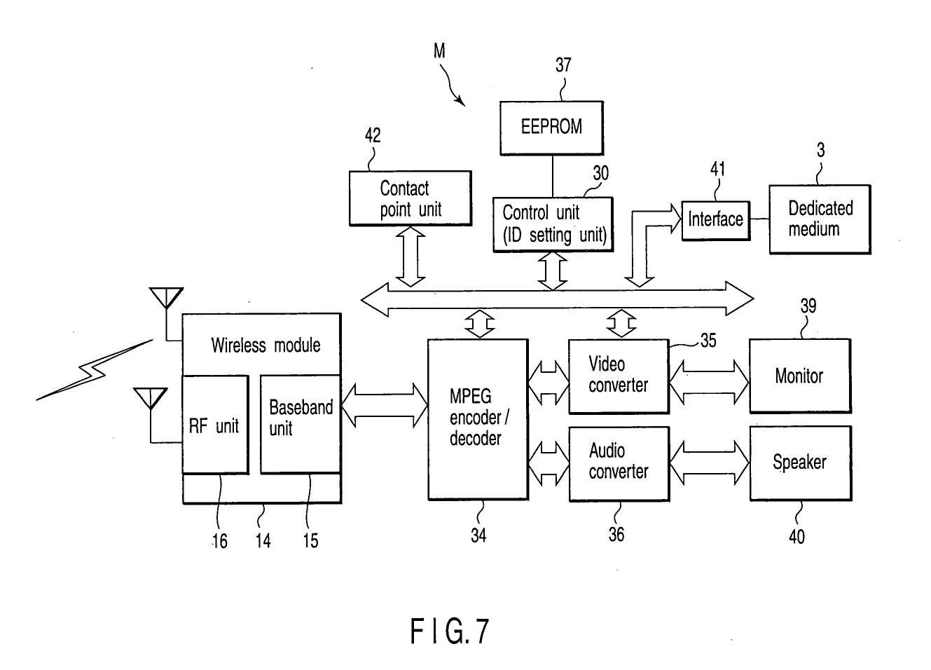

Referring to the accompanying drawings, preferred embodiments of the invention will be described in detail. FIG. 1 shows an example of connection and communication between a transmitting apparatus and a receiving apparatus according to the invention, FIG. 2 shows an example of the connection and the communication between the transmitting apparatus and the receiving apparatus which are of cradles according to the invention, FIG. 3 shows another example of the connection and the communication between the transmitting apparatus and the receiving apparatus according to the invention, FIG. 4 is a block diagram showing an example of a configuration of the transmitting apparatus according to the invention, FIG. 5 is the block diagram showing an example of the configuration of the receiving apparatus according to the invention, FIG. 6 is the block diagram showing another example of the configuration of the transmit-ting apparatus according to the invention, and FIG. 7 is the block diagram showing another example of the configuration of the receiving apparatus according to the invention.

[Configuration of Transmitting Apparatus and Receiving Apparatus of the Invention]

As shown in FIG. 1, in a first embodiment of the transmitting apparatus and the receiving apparatus according to the invention, identification information (ID) is supplied between a transmitting apparatus ST and receiving apparatuses M1 and M2 through a dedicated cable 1. As shown in FIG. 2, in a second embodiment, a cradle C which is the transmitting apparatus and the receiving apparatus M2 is mounted, and the identification information (ID) is supplied through a contact point unit 20. It is possible that the contact point unit 20 is the dedicated connector, or it is possible the contact point unit 20 is a plate-shaped metal terminal which transmits a signal by insulation displacement. In a third embodiment, the identification information (ID) is supplied through dedicated medium 3 shown in FIG. 6. Therefore, since the identification information (ID) is not supplied by wireless transmission, the receiving apparatus can be easily added to scale up the system while malicious theft of the identification information (ID) by a third party can be prevented.

A wireless TV is an example of the transmitting apparatus ST and the receiving apparatus M according to the invention. As shown in FIG. 3, the wireless TV includes the transmitting apparatus ST which is called a station and the receiving apparatus M. A video cassette recorder V, a DVD player D, and the like are connected to the transmitting apparatus ST and the receiving apparatus M has a display screen such as a flat display. A tuner is equipped with the transmitting apparatus ST and an antenna cable is connected to the transmitting apparatus ST.

In the wireless TV, a video cable connection between the transmitting apparatus ST which is the station and the receiving apparatus M which is the display side is removed, and the image is wirelessly transmitted between the transmitting apparatus ST and the receiving apparatus M. The wireless TV is realized by eliminating the cable.

The transmission method of IEEE802.11b at 2.4 GHz or IEEE802.11a at 5 GHz is preferable to the wireless communication. The transmission of about 5 Mbps can be normally performed as an effective rate of an image in IEEE802.11b and the transmission of about 15 Mbps can be normally performed in IEEE802.11a, so that the image and speech are generally compressed into MPEG2 to perform the transmission.

As shown in FIG. 4, the station ST which is an example of the transmitting apparatus includes a tuner unit 9. The tuner unit 9 receives an analog broadcasting signal obtained by tuning a specific frequency, demodulates the analog broadcasting signal, and outputs an analog video signal and an analog audio signal, or the tuner unit 9 receives a digital broadcasting signal, demodulates the digital broadcasting signal, and outputs a digital video signal and a digital audio signal. The transmitting apparatus ST includes a video converter 11, an audio converter 12, and an MPEG encoder/decoder 13. The tuner unit 9 supplies the analog video signal and the analog audio signal to the video converter 11 and the audio converter 12. The video converter 11 and audio converter 12 or the tuner unit 9 supplies the digital video signal and the digital audio signal to the MPEG encoder/decoder 13.

The transmitting apparatus ST includes a control unit 10 and an EEPROM 17 which is a storage unit connected to the control unit 10. The control unit 10 performs control operation of the whole of transmitting apparatus and has an ID setting function which is the feature of the invention. The transmitting apparatus ST also includes a wired Ethernet unit 18 connected to a data bus and a connector 2 which can be connected to a cable 1 having a shape unique to the transmission system (or connected to a general purpose cable). Further, the transmitting apparatus ST includes a wireless module 14. In the wireless module 14, video information encoded by the MPEG encoder 13 is supplied, the video information is modulated to form a transmission signal, and the transmission signal is transmitted to a receiving apparatus M located on the display side which is the party at the other end of the wireless TV. For example, the wireless module 14 has a baseband unit 15 and an RF unit 16.

On the other hand, as shown in FIG. 5, the monitor apparatus M which is an example of the receiving apparatus includes a wireless module 31. The wireless module 14 of the transmitting apparatus ST which is the party at the other end of the wireless TV wirelessly transmits the video information to the wireless module 31. The wireless module 31 has an RF unit 32 and a baseband unit 33. The receiving apparatus M includes an MPEG encoder/decoder 34 which performs the decoding of the signal supplied from the wireless module 31, a video converter 35 which converts the decoded digital video signal into the analog video signal, and an audio converter 36 which converts the decoded digital audio signal into the analog audio signal. A video output from the video converter 35 is output to a monitor unit 39 to display the image, and the speech is output from a speaker 40.

The receiving apparatus M includes a control unit 30 and an EEPROM 37 which is a storage unit connected to the control unit 30. The control unit 30 performs control operation of the whole of transmitting apparatus and has the ID setting function which is the feature of the invention. The receiving apparatus M also includes a wired Ethernet unit 38 connected to the data bus and the connector 2 which can be connected to the cable 1 having the shape unique to the transmission system (or connected to the general purpose cable).

In the transmitting apparatus ST having the above-described configuration, the following basic operations are performed. After NTSC decode processing of the analog video signal is performed by the video converter 11, the video signal is converted into MPEG2-TS by the MPEG encoder 13, and the wireless processing is performed by the wireless module 14. The analog audio signal is converted into a PCM signal by the audio converter 12, the PCM signal is compressed and converted into MPEG2-TS by the MPEG encoder 13, and MPEG2-TS data is input to the wireless module 14. In the wireless module 14, the baseband unit 15 which perform baseband demodulation processing and the RF unit 16 bears the MPEG2-TS data on a frame of the radio signal to transmit the MPEG2-TS data by IEEE802.11a which is the wireless transmission method in the 5G band or IEEE802.11b which is the wireless transmission method in the 2.4G band.

In the above-described receiving apparatus M, the following basic operations are performed. Namely, the reverse processing of the transmitting apparatus ST is performed in the monitor apparatus M. The data wirelessly transmitted from the station ST is returned to the MPEG2-TS data by the baseband processing of the RF unit 32 and the baseband unit 33 in the wireless module 31, and the MPEG2-TS data is decoded by the MPEG2 decoder 34. In the video signal, RGB output is output to the monitor 39 by the video converter 35. The audio signal is output from the speaker 40 after digital to analog conversion is performed by the audio converter 36.

Although the image data is wirelessly transmitted from the station ST side to the monitor apparatus M side, because the wireless communication is easily intercepted, from the viewpoint of security, recently it is often the case that the data is transmitted after the data is encrypted in the wireless baseband processing of the baseband units 15 and 33. When both the transmitting side and the receiving side do not have a key for decoding the encryption, the data encrypted by the transmitting side can not be decoded on the receiving side. In the communication between personal computers, generally the same password is input by the personal computer of the transmitting side and the personal computer of the receiving side, the encryption key is generated by the same algorithm on the basis of the same password, and the encrypted data can be decoded by the receiving side.

(Outline of Security of Wireless LAN)

Then, an outline concerning the security of wireless LAN will be described (see “A Guideline concerning the security of wireless LAN” published by JEITA).

“The reason why the security function is required for wireless LAN” will be first described. In order to simply construct LAN environment with no trouble of wiring, the wireless LAN is designed so that the personal computer and a wireless access point with which the wireless LAN is equipped can perform the mutual communication of any device with no particular setting. At the same time, unless the security is set in the wireless LAN, anyone can intercept a communication message or invade the network without using a particular tool within the range where the radio signal of the wireless LAN can reach. Therefore, it should be considered that measures for the security in the wireless LAN is required more than in wire LAN.

Then, “types of the security functions of the wireless LAN” are cited below. In the wireless LAN of IEEE802.11 method which is extensively used at the present day, the following security functions which end users can easily set are prepared for the measures for the security.

(1) SSID (Service Set Identifier): Only wireless LAN terminals in which the same SSID are set can be connected by setting an identifier of the network (SSID) to the access point.

(2) Setting of a WEP (Wired Equivalent Privacy) key: The data is encrypted between the access point and the wireless LAN terminal by the common encryption key.

Then, “the setting of SSID” will be described. Because SSID is set to a manufacture's setting value in an initial state, it is necessary to set a unique name in the user's network in order to distinguish the user's network from other networks. However, since the set SSID can be easily seen by a third party, it can not be expected that SSID has the security function. On the contrary, when the user sets SSID to such a name as a family name or an organization name of the user which can specify the user, there is a possibility that the third party wrongly has an interest. Therefore, it is recommended that the name whose meaning is not caught as much as possible is set.

Then, “the setting of WEP” will be described. WEP is the function which encrypts the data in a wireless interval, and WEP is the security function which is the most effective at the present moment. Because WEP becomes invalid in the initial state, it is preferable that the encryption key (WEP key) is set to make WEP valid without fail. When the 128-bit key and the 64-bit WEP key can be set, it is preferable to select the 128-bit key in order to make it difficult to decode the encryption. Further, it is preferable that the WEP key is periodically changed on the assumption that the WEP key is broken.

Then, “MAC address filtering” will be described. The MAC address filtering is the function which prohibits the connection to the access point except the device having a registered MAC address, and the MAC address filtering has an effect on the prevention of the invasion. However, the MAC address filtering has no effect on the prevention of the interception. Further, there is a possibility that the MAC address is intercepted by the dedicated tool, so that it preferable to use both the MAC address filtering and WEP.

There is the above-described guideline and currently the above-described setting is performed in many personal computers. However, as described in the guideline, in the above-described method, any user can wirelessly communicate with any personal computer in which the above-described setting is performed as long as the password is found. For example, a stranger in another room or another house which is located in the range where the radio signal reaches can easily perform the interception as long as the password is found. This is because there are still many worries about the security in the wireless LAN.

In the case of TV, a program is wirelessly transmitted. The program includes a pay program and the program having the copyright, so that it is necessary that the security is further improved. Unlike the personal computer, since a user interface such as keyboard input is less common in TV, it is not preferable to adopt the method in which the user inputs the password to the station and the monitor.

Therefore, in the prior art, a pair of unique IDs is written in the transmitting side and the receiving side in manufacturing the wireless TV, and the processing in which IDs are mutually confirmed is performed in transmitting the content. However, in this method, the identification information becomes valid only between the pair of the transmitting apparatus and the receiving apparatus of purchasing, and it is difficult to easily set ID even if the user purchases the additional monitor which is the receiving apparatus. The setting the identification information through the conductor according to the invention is the transmission system in which the identification information (ID) is given to the receiving apparatus from the transmitting apparatus by utilizing the conductor such as the cable, and the communication of the content is performed by the wireless transmission after the receiving apparatus is authenticated, thereby the receiving apparatus can be easily added while the identification information is prevented from intercepting in the wireless transmission. The setting and application of the identification information will be described in detail below referring to the accompanying drawings.

[Operations of Transmitting Apparatus and Receiving Apparatus According to First Embodiment of the Invention]

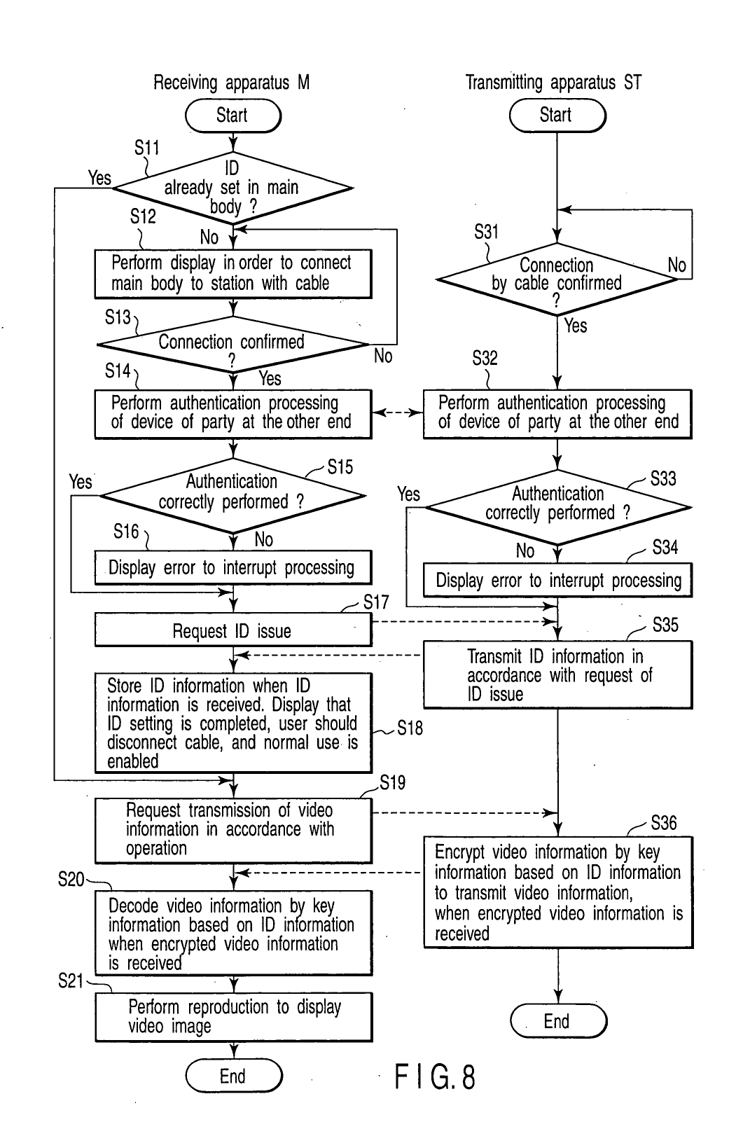

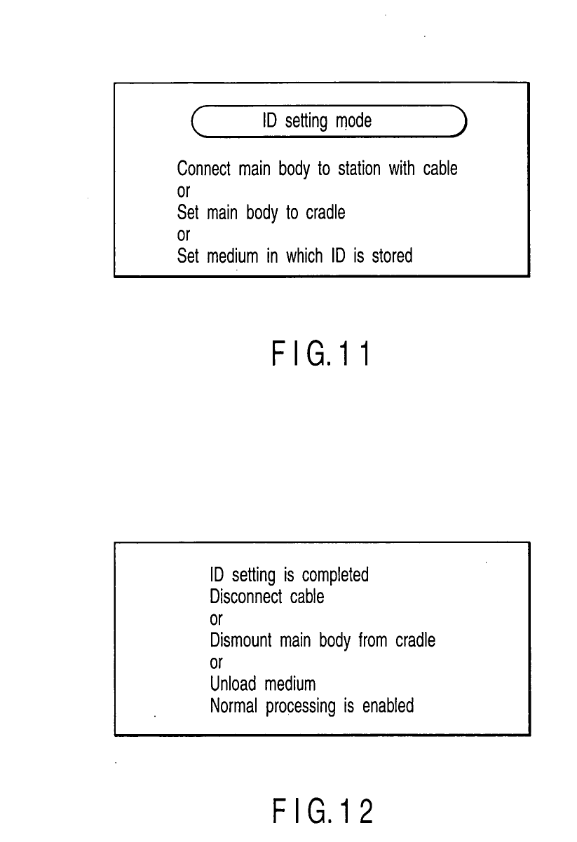

A first embodiment of the invention specifies the transmission system and the transmission method in which the dedicated cable is connected between the transmitting apparatus and the receiving apparatus to supply the identification information (see FIGS. 1, 4, and 5). FIG. 8 is a flowchart showing an example of ID setting and communication processing between the transmitting apparatus and the receiving apparatus according to a first embodiment of the invention, FIG. 11 shows an example of an operation screen for prompting the user to perform the ID setting of the receiving apparatus according to the invention, and FIG. 12 shows an example of the operation screen showing completion of the ID setting.

As shown in FIG. 1, the transmitting apparatus ST and the receiving apparatus M according to the first embodiment set the identification information (ID) by using the dedicated cable 1 made of the conductor. Therefore, as described above in FIGS. 4 and 5, the dedicated connectors 2 for the dedicated cable 1 are in the transmitting apparatus ST and the receiving apparatus M. At this point, the dedicated connector 2 for the dedicated cable 1 which is not normally distributed in the commercial market is preferable in order to further improve the security. However, even if the general-standard cable and connector are used, the invention can have the good security and the easy extension characteristics of the system when compared with the prior art.

The ID setting will be described in detail referring to the flowchart shown in FIG. 8. When the receiving apparatus M is started up, whether ID is already set in a main body of the receiving apparatus M or not is confirmed by an ID setting function (working of a program in an EEPROM 17) of the control unit 10 (S11). When ID is already set, the transmission steps from Step S19 which are the normal transmission between the transmitting apparatus ST and the receiving apparatus M are performed. When ID is not set, an ID setting mode is started and the monitor 39 performs the display for prompting the user to provide the connection between the main body of the receiving apparatus M and the station of the transmitting apparatus ST with the dedicated cable 1 as shown in FIG. 11 (S12). At this point, when the connection between the transmitting apparatus ST and the receiving apparatus M is confirmed (S13), authentication processing that the transmitting apparatus ST of the party at the other end is the justifiable device is performed (S14). On the other hand, in the transmitting apparatus ST, when the connection by the cable 1 is confirmed (S31), the authentication processing of the device of the party at the other end is similarly performed (S32).

When the authentication processing fails at both the transmitting apparatus ST and the receiving apparatus M, the display of an error is performed on the monitor 39 to interrupt the processing (S16 and S34). When the authentication is correctly performed, in order to prompt the user to issue an ID in accordance with the operation of the control unit 10, the receiving apparatus M transmits an ID issue request signal through the cable 1 without waiting for the user's operation (S17).

The transmitting apparatus ST transmits the ID information through the cable 1 according to the ID issue request signal (S35). In this case, the ID information is a specific data string. It is also preferable to transmit computing result in which the ID information is calculated by a specific function. When the ID information is received in the receiving apparatus M, the ID information is stored in a storage area such as an EEPROM 17. As shown in FIG. 12, the completion of the ID setting is acknowledged, the user is prompted to disconnect the cable, and the monitor 39 displays that the normal transmission processing between the transmitting apparatus ST and the receiving apparatus M is enabled (S18).

Then, the normal transmission processing can be performed. At this point, it is preferable that the normal transmission processing is also performed subject to the disconnection of the cable. Further, it is preferable that, before the wireless transmission of the video data and the audio data, the authentication processing is performed between the transmitting apparatus ST and the receiving apparatus M to confirm that the transmitting apparatus ST and the receiving apparatus M have the same ID.

In the receiving apparatus M, the normal transmission processing is performed such that the user operates an operation panel of the monitor which is the receiving apparatus M and a request signal for watching a specific channel is wirelessly transmitted to the station which is the transmitting apparatus ST (S19). In accordance with the normal transmission processing in the receiving apparatus M, in the transmitting apparatus ST, the broadcasting signal of a specific broadcasting station is selected and demodulated by the tuner 9, and the broadcasting signal is converted into the video signal and the audio signal by the MPEG decoder 13. Then, the encryption key information according to the ID information is generated by actions of the control unit 10 and the wireless module 14, the video signal and audio signal are encrypted on the basis of the encryption key information to wirelessly transmit the encrypted video signal and audio signal (S36). At this point, although it is not always necessary to perform the encryption according to the ID information by the encryption key, the encryption processing can further improve the security.

Then, in the receiving apparatus M, the encrypted video information is received by the wireless module 31, the encryption key according to the ID information is generated by the actions of the control unit 30 and the wireless module 31, the encrypted video information is decoded by the encryption key (S20). After he necessary decoding process of the decoded video information is performed by the MPEG decoder 34, the video information is converted into the video signal which is the analog signal by the video converter 35 to be displayed on the screen by the monitor 39 (S21). Similarly, the video information is converted into the audio signal which is the analog signal by the audio converter 36 to be output from the speaker 40.

In the transmission system according to the invention, since the identification information (ID) is set through the conductor such as the cable by the above-described procedure, it is avoided that the third party maliciously intercepts the wireless signal to steal an ID and then the pay channel and the like are maliciously intercepted with a personal computer by using the ID. Therefore, while the security of the content is certainly protected, as shown in FIG. 1, the ID setting can be easily performed to the monitor apparatus M1 which is the first receiving apparatus and the additional monitor apparatus M2 by simple plug-in play operation. As a result, the invention easily takes a one-to-many mode for the transmitting apparatus and the receiving apparatus, while the prior art takes a one-on-one mode of the pair of the transmitting apparatus and the receiving apparatus.

[Operations of Transmitting Apparatus and Receiving Apparatus According to Second Embodiment]

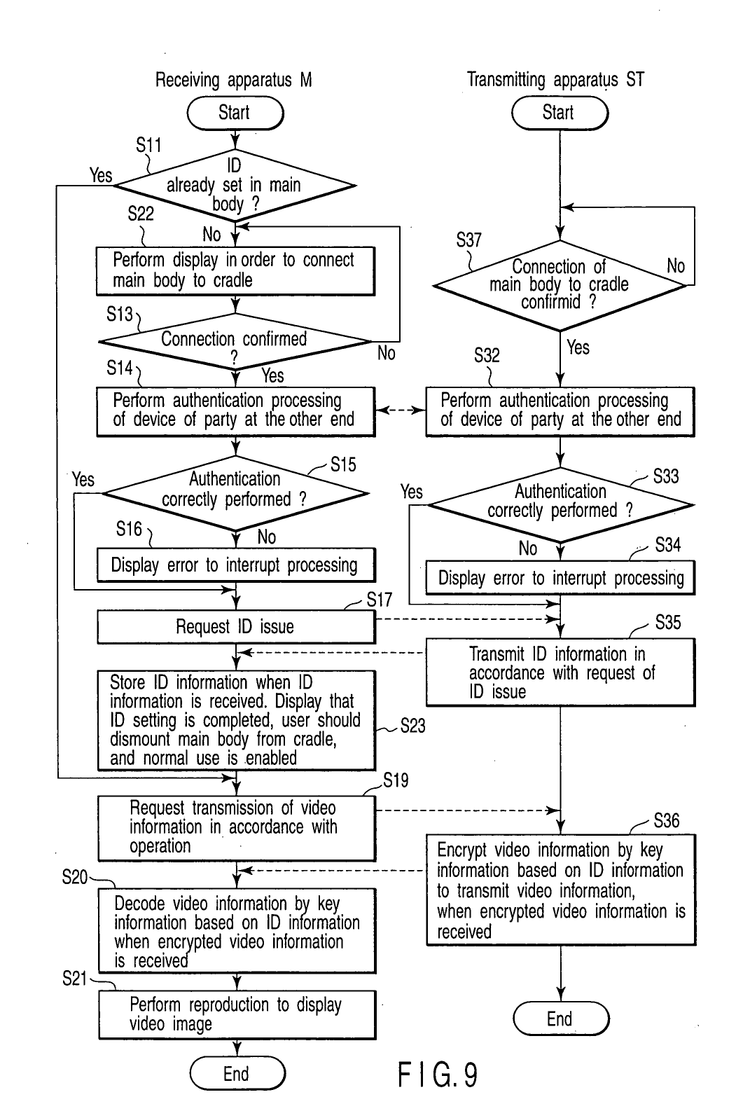

A second embodiment of the invention specifies the transmission system and the transmission method in which the cradle and the monitor are provided as the transmitting apparatus and the receiving apparatus and contact point units of both the transmitting apparatus and the receiving apparatus are made of the conductor to supply the identification information (see FIGS. 2, 6, and 7). FIG. 9 is the flowchart showing an example of the ID setting and the communication processing between the transmitting apparatus and the receiving apparatus according to the second embodiment of the invention, FIG. 11 shows an example of the operation screen for prompting the user to perform the ID setting of the transmitting apparatus according to the invention, and FIG. 12 shows an example of the operation screen showing the completion of the ID setting.

As shown in FIG. 2, in the transmitting apparatus ST and the receiving apparatus M according to the second embodiment, the cradle C in which the tuner is incorporated is formed as the transmitting apparatus ST, the receiving apparatus M2 is provided as the apparatus which can be attached to the cradle C, the contact point unit 20 of the cradle is made of the conductor, and ID is transmitted. At this point, it is possible that the contact point 20 is the dedicated connector, or it is possible the contact point unit 20 is the plate-shaped metal terminal which transmits the signal by insulation displacement.

FIG. 6 shows the block diagram of the cradle C which is the transmitting apparatus ST of the second embodiment. The transmitting apparatus ST shown in FIG. 6 basically has the same configuration as the transmitting apparatus ST shown in FIG. 4 except that the contact point unit 20 of the cradle C is provided. Further, in FIG. 6, the dedicated medium 3 and an interface (I/F) 19 which are used in the third embodiment are provided.

FIG. 7 shows the block diagram of the receiving apparatus M of the second embodiment. The receiving apparatus M shown in FIG. 7 basically has the same configuration as the receiving apparatus M shown in FIG. 5 except that the contact point unit 42 of the cradle C is provided. Further, in FIG. 7, the dedicated medium 3 and an interface (I/F) 41 which are used in the third embodiment are provided.

The process of setting the identification information ID between the transmitting apparatus ST and the receiving apparatus M in the above-described configuration will be described below referring to the flowchart shown in FIG. 9. When the receiving apparatus M is started up, whether ID is already set in the main body of the receiving apparatus M or not is confirmed by the ID setting function (working of the program in an EEPROM 17) of the control unit 10 (S11). When ID is already set, the transmission steps from Step S19 which are the normal transmission between the transmitting apparatus ST and the receiving apparatus M are performed. When ID is not set, the ID setting mode is started and the monitor 39 performs the display for prompting the user to mount the main body of the receiving apparatus M on the transmitting apparatus ST which is the cradle C as shown in FIG. 11 (S22). At this point, when the connection between the transmitting apparatus ST and the receiving apparatus M is confirmed (S13), the authentication processing that the transmitting apparatus ST of the party at the other end is the justifiable device is performed (S14). On the other hand, in the transmitting apparatus ST, when the connection by the contact point unit 20 of the cradle C is confirmed (S31), the authentication processing of the device of the party at the other end is similarly performed (S32).

When the authentication processing is failed at both the transmitting apparatus ST and the receiving apparatus M, the display of the error is performed on the monitor 39 to interrupt the processing (S16 and S34). When the authentication is correctly performed (S15), in order to prompt the user to issue an ID in accordance with the operation of the control unit 10, the receiving apparatus M transmits the ID issue request signal through the contact point unit 20 of the cradle C without waiting for the user's operation (S17).

The transmitting apparatus ST transmits the ID information through the contact point unit 20 of the cradle c in accordance with the ID issue request signal (S35). In this case, the ID information is a specific data string. It is also preferable to transmit the computing result in which the ID information is calculated by a specific function. When the ID information is received in the receiving apparatus M, the ID information is stored in the storage area such as an EEPROM 17. As shown in FIG. 12, the completion of the ID setting is acknowledged, the user is prompted to dismount the monitor apparatus M from the cradle C, and the monitor 39 displays that the normal transmission processing between the transmitting apparatus ST and the receiving apparatus M is enabled (S23).

Then, the normal transmission processing is performed. At this point, it is preferable that the normal transmission processing is also performed subject to the dismounting of the monitor apparatus M from the cradle C. Further, it is preferable that, before the wireless transmission of the video data and the audio data, the authentication processing is performed between the transmitting apparatus ST and the receiving apparatus M to confirm that the transmitting apparatus ST and the receiving apparatus M have the same ID.

Because the same processes as the flowchart shown in FIG. 8 are performed in the subsequent steps (S19, S20, S21, and S36), the descriptions are omitted.

In the second embodiment, since the identification (ID) is set by using the contact point unit of the cradle as the conductor, it is avoided that the third party maliciously intercepts the wireless signal to steal an ID and then the pay channel and the like are maliciously intercepted with a personal computer by using the ID.

[Operations of Transmitting Apparatus and Receiving Apparatus According to Third Embodiment]

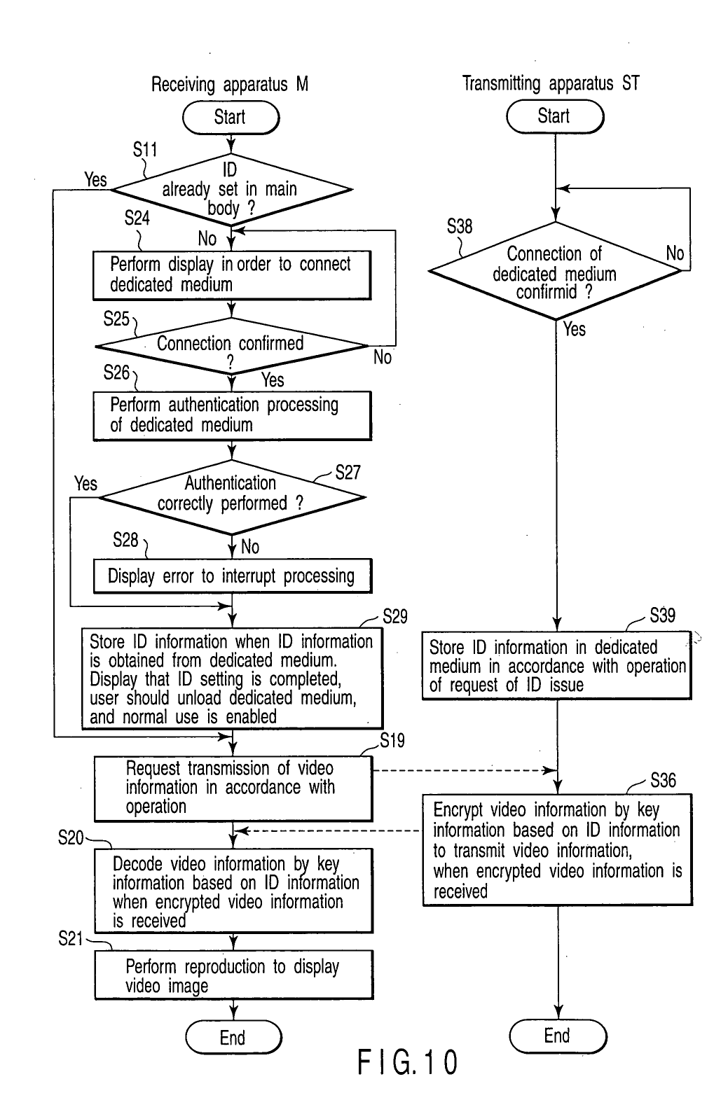

A third embodiment of the invention specifies the transmission system and the transmission method in which the dedicated recording medium is used and the identification information is supplied by using the interface of the dedicated recording medium as the conductor (see FIGS. 6 and 7). FIG. 10 is the flowchart showing an example of the ID setting and the communication processing between the transmitting apparatus and the receiving apparatus according to the third embodiment of the invention, FIG. 11 shows an example of the operation screen for prompting the user to perform the ID setting of the receiving apparatus according to the invention, and FIG. 12 shows an example of the operation screen showing completion of the ID setting.

The transmitting apparatus ST and the receiving apparatus M according to the third embodiment share the identification information through the dedicated recording medium. FIG. 6 shows the block diagram of the transmitting apparatus ST of the third embodiment. The transmitting apparatus ST shown in FIG. 6 basically has the same configuration as the transmitting apparatus ST shown in FIG. 4 except that the dedicated medium 3 and the interface 19 of the dedicated medium 3 are provided.

FIG. 7 shows the block diagram of the receiving apparatus M of the third embodiment. The receiving apparatus M shown in FIG. 7 basically has the same configuration as the receiving apparatus M shown in FIG. 5 except that the dedicated medium 3 and the interface 41 of the dedicated medium 3 are provided.

The process of setting the identification information ID between the transmitting apparatus ST and the receiving apparatus M in the above-described configuration will be described below referring to the flowchart shown in FIG. 10. When the receiving apparatus M is started up, whether ID is already set in the main body of the receiving apparatus M or not is confirmed by the ID setting function (working of the program in an EEPROM 17) of the control unit 10 (S11). When ID is already set, the transmission steps from Step S19 which are the normal transmission between the transmitting apparatus ST and the receiving apparatus M are performed. When ID is not set, the ID setting mode is started and the monitor 39 performs the display for prompting the user to mount the dedicated medium 3 on the main body of the receiving apparatus M as shown in FIG. 11 (S24). At this point, when the mounting of the dedicated medium 3 is confirmed (S25), the authentication processing whether that the dedicated medium 3 is justifiable or not is performed (S26).

On the other hand, in the transmitting apparatus ST, the storage of the identification into the dedicated medium 3 is performed independently of the operation procedure of the receiving apparatus M. Namely, the user loads the dedicated medium 3 on the interface 19 of the transmitting apparatus ST. When it is confirmed that the dedicated medium 3 is justifiable (S38), the operation for issuing an ID is performed in the transmitting apparatus ST by the user's operation. In accordance with the operation, the identification information is stored in the dedicated medium 3 by the action of the control unit 10 (S39). At this point, instead of the data string of the identification information ID, it is possible that the identification information is the computing result in which predetermined computing processing is performed.

On the other hand, when it is not authenticated that the dedicated recording medium 3 is justifiable, the display of the error is performed to interrupt the processing (S28). When the authentication of the dedicated recording medium 3 is correctly performed (S27), the receiving apparatus M obtains the identification information from the dedicated recording medium 3 in accordance with the operation of the control unit 10 to store the identification information in an EEPROM 17 which is the recording unit. Then, the receiving apparatus M acknowledges the user of the completion of the ID setting, prompts the user to unload the dedicated recording medium 3 from the interface 19, and displays on the monitor 39 or the like that the transmission processing between the normal transmitting apparatus ST and the receiving apparatus M is enabled (S29).

Then, the normal transmission processing is performed. At this point, it is preferable that the normal transmission processing is also performed subject to the unloading of the dedicated recording medium 3 from the interface 19. Further, it is preferable that, before the wireless transmission of the video data and the audio data, the authentication processing is performed between the transmitting apparatus ST and the receiving apparatus M to confirm that the transmitting apparatus ST and the receiving apparatus M have the same ID.

Because the same processes as the flowchart shown in FIG. 8 are performed in the subsequent steps (S19, S20, S21, and S36), the descriptions are omitted.

In the third embodiment, since the identification information (ID) is set by using the dedicated recording medium 3 and the interface 19 used as the conductor, it is avoided that the third party maliciously intercepts the wireless signal to steal an ID and then the pay channel and the like are maliciously intercepted with a personal computer by using the ID. The dedicated recording medium 3 is not the type which is available in the commercial market, and it is preferable to use the dedicated recording medium 3. However, even if the general type of medium such as an SD (Smart Disk) card is used, the same action and effect can be realized.

As described above, in the receiving apparatus according to the invention, the unique identification information (ID) given to the receiving apparatus from the transmitting apparatus is supplied through the conductor such as the cable. After the identification information is transmitted from the transmitting apparatus to the receiving apparatus, the cable or the like is disconnected, it is decided that the identification information is justifiable, and the content and the like are transmitted from the transmitting apparatus to the receiving apparatus. Thus, the user can easily give the identification information by using the cable or the like from the transmitting apparatus to the additional receiving apparatus which is purchased after that, so that the user can easily extend the transmission and reception system after the first purchase of the system.

On the other hand, in the system, the identification information can not be obtained unless the transmission is performed through the conductor such as the cable, the cradle, and the medium, and the identification information is not often transmitted by the wireless transmission. For example, it can be avoided that the next-door third party steals the identification information to intercept the pay content from the user's transmitting apparatus only by the receiving apparatus of the next-door third party. Therefore, while the security is maintained, the transmission system can be easily extended such that the number of receiving apparatuses is increased. Further, the transmission system and the transmission method based on the same principle are further disclosed by the invention.

Although those skilled in the art can realized the invention by the embodiments disclosed above, it is further understood that those skilled in the art can easily make various changes and modifications in the invention and apply the invention to various embodiments without any inventive ability. Therefore, the invention covers the broad range consistent with the disclosed principles and the novel features, and the invention is not limited to the above-described embodiments.

For example, in the above-described embodiments, although the transmission system according to the invention was described by using the examples of the monitor and the station having the TV tuner function, the invention can be similarly applied to the general transmission system.

1. A receiving apparatus comprising:
an input unit which obtains identification information from an external transmitting apparatus through a conductor; and
a receiving unit which receives and decodes information wirelessly transmitted from the transmitting apparatus when the identification information given from the input unit permits decoding.

2. A receiving apparatus according to claim 1, wherein the conductor used in the input unit is a cable which connects the receiving apparatus and the transmitting apparatus.

3. A receiving apparatus according to claim 1, wherein the conductor used in the input unit is a contact point unit connected to the transmitting apparatus.

4. A receiving apparatus according to claim 1, wherein the conductor used in the input unit is a medium interface which can be connected to a recording medium in which the identification information is stored.

5. A receiving apparatus according to claim 4, wherein a type of the recording medium used in the input unit is unique to the transmitting apparatus and the receiving apparatus.

6. A receiving apparatus according to claim 1, wherein the receiving unit generates key information on the basis of the identification information obtained by the input unit and decodes the information wirelessly transmitted from the transmitting apparatus on the basis of the key information.

7. A receiving apparatus according to claim 1, wherein whether the identification information exists or not is decided in starting up the receiving apparatus, and display for prompting a user to perform operation for obtaining the identification information from the transmitting apparatus is performed when the identification information does not exist.

8. A receiving apparatus according to claim 7, wherein the operation which the user is prompted to perform is to connect the transmitting apparatus and the receiving apparatus with the cable made of the conductor.

9. A receiving apparatus according to claim 7, wherein the operation which the user is prompted to perform is to electrically connect the transmitting apparatus and the receiving apparatus through the contact point unit by mounting a main body of the receiving apparatus on the main body of the transmitting apparatus.

10. A receiving apparatus according to claim 1, further comprising a display unit in which the receiving unit receives encrypted video information supplied from the transmitting apparatus, decodes the encrypted video information on the basis of the key information according to the identification information, and displays a reproduced video image.

11. A transmission system comprising:
a transmitting apparatus having an output unit which supplies identification information through a conductor and a transmitting unit which encrypts predetermined information to wirelessly transmit the predetermined information;
an input unit which obtains the identification information from the output unit of the transmitting apparatus through the conductor; and
a receiving unit which receives and decodes the information wirelessly transmitted from the transmitting unit of the transmitting apparatus when the identification information permits decoding.

12. A transmission system according to claim 11, wherein the conductor used in the input unit of the receiving apparatus is a cable which connects the receiving apparatus and the transmitting apparatus.

13. A transmission system according to claim 11, wherein the conductor used in the input unit is a contact point unit connected to the transmitting apparatus.

14. A transmission system according to claim 11, wherein the conductor used in the input unit of the receiving apparatus is a medium interface which can be connected to a recording medium in which the identification information is stored.

15. A transmission system according to claim 11, wherein the receiving unit of the receiving apparatus generates key information on the basis of the identification information obtained by the input unit and decodes the predetermined information wirelessly transmitted from the transmitting apparatus on the basis of the key information.

16. A transmission system according to claim 11, wherein whether the identification information exists or not is decided in starting up the receiving apparatus, and display for prompting a user to perform operation for obtaining the identification information from the transmitting apparatus is performed when the identification information does not exist.

17. A transmission method in which a receiving apparatus receives predetermined information wirelessly transmitted from a receiving apparatus, wherein
the receiving apparatus obtains identification information from the transmitting apparatus through a conductor; and
the receiving apparatus receives and decodes the predetermined information wirelessly transmitted from the transmitting unit of the transmitting apparatus when the identification information permits decoding.

18. A transmission method according to claim 17, wherein the conductor used in the input unit of the receiving apparatus is a cable which connects the receiving apparatus and the transmitting apparatus.

19. A transmission method according to claim 17, wherein the conductor is a contact point unit connected to the transmitting apparatus.

20. A transmission method according to claim 17, wherein the conductor used in the receiving apparatus is a medium interface which can be connected to a recording medium in which the identification information is stored.
